(19) United States
(12) Patent Application Publication
(10) Pub. No.: US 2016/0001698 A1
(43) Pub. Date: Jan. 7, 2016

(54) STEERING WHEEL MOUNTED INDICATOR SYSTEM

(71) Applicant: WEEL INVENTIONS PTY LIMITED, Jerrabomberra, New South Wales (AU)

(72) Inventors: John David HALL, Jerrabomberra (AU); Robert Andrew John KING, Berridale (AU)

(21) Appl. No.: 14/768,777

(22) PCT Filed: Feb. 19, 2014
(86) PCT No.: PCT/AU2014/000148

§ 371 Date: Aug. 19, 2015

(30) Foreign Application Priority Data
Feb. 19, 2013 (AU) 2013900556

(51) Int. Cl. B60Q 1/34; B60Q 1/42

(52) U.S. Cl. CPC B60Q 1/34; B60Q 1/42

(57) ABSTRACT

A steering wheel system for a vehicle having turn indicators has at least two sensing areas (14, 16) mounted upon or integrated within the steering wheel rim (10), wherein a driver action upon one or more of the sensing areas (14, 6) selectively activates or deactivates the turn indicators of the vehicle.

### FIELD OF INVENTION

This invention relates to means for activating vehicle turn indicators, in particular to means located upon the steering wheel of a vehicle.

### BACKGROUND

Vehicle turn indicator systems are well known in the art. These systems typically consist of an indicator stalk located on either left side or right side of the steering column, usually the left side on European-manufactured cars (whether left hand drive or right hand drive) and on the right side on Japanese-manufactured cars (usually right hand drive). A driver indicates their intention to turn right by activating a small clockwise motion of the indicator stalk, while an intention to turn left is activated by a small anticlockwise motion of the indicator stalk.

Non-standardised positioning of the indicator stalk on the left/right side provides confusion where drivers have a mix of European and non-European model cars, and this confusion can cause safety issues to arise in emergency situations.

Furthermore, some drivers may have difficulty in activating steering column mounted stalks without removing their grip from the steering wheel.

### SUMMARY OF THE INVENTION

In one broad form, the present invention provides a steering wheel with at least two sensing regions mounted upon or integrated within the steering wheel rim, wherein a driver action upon one or more of the sensing regions selectively activates or deactivates the turn indicators of a vehicle.

The sensing regions may be comprised of one or more areas sensor areas or points.

The sensing regions or areas may be comprised of one or more membrane sensor pads.

Preferably there is a left sensing area wherein a driver action upon the left sensing area activates the left turn indicator of the vehicle and a right sensing area wherein a driver action upon the right sensing area activates the right turn indicator of the vehicle.

Preferably the left sensing area is located at a “10 o'clock” position of the steering wheel in its straight ahead position and the right sensing area is located at a “2 o'clock” position of the steering wheel in its straight ahead position. However, one or more sensor areas may extend around a significant portion of the rim, such as from the 8 to 11 o'clock positions for the left indicator area(s) and from the 1 to 5 o'clock for the right indicator area(s).

The left and right sensing areas may be fixed relative to the steering wheel or may be dynamically mapped. Where dynamically mapped a sensor area may be mapped as a left or right sensing area depending on its position relative to the steering wheel centreline.

Preferably the system is programmable so that a specified driver action on a sensing area activates a specified indication sequence on the vehicle turn indicators.

Preferably the driver action upon a sensing area comprises squeezing or clenching the steering wheel rim portion at the location of a sensing area a specified number of times.

Preferably squeezing or clenching the steering wheel rim portion at the location of a sensing area two times activates a specified number of vehicle indicator blinks.

Preferably squeezing or clenching the steering wheel rim portion at the location of a sensing area a programmable number of times activates an unspecified number of vehicle indicator blinks which terminate upon a specified indication cancel action.

The indication cancel action may be the action of the steering wheel returning to the straight ahead position, or it may be a programmable driver action upon one or more of the sensing areas.

The steering wheel may provide one or more of

visual notification,

audio notification,

tactile notification

corresponding to an action of the vehicle turn indicator. Suitable notifiers such as lights, audio generators and vibrators may be incorporated into the steering wheel.

In another broad form, the present invention provides a steering wheel with multiple sensing areas spaced around the steering wheel rim, and a sensor which senses the rotational position of the steering wheel, wherein the turn indicators of a vehicle are selectively activated by combination of:

a signal or signals generated in response to a programmable driver action upon one or more of the sensing areas, and

a signal representing the rotational position of the steering wheel.

Preferably a driver action upon any sensing area in the left half of the rotated steering wheel corresponds to the activation of a vehicle's left turn indicator, and a driver action upon any sensing area in the right half of the rotated steering wheel corresponds to the activation of a vehicle's right turn indicator.

### BRIEF DESCRIPTION OF THE DRAWINGS

FIG. 1 shows a steering wheel with two sensing areas according to one embodiment of the invention.

FIG. 2 shows an example of a membrane sensor pad used to form the sensing areas of this invention.

FIG. 3 shows a steering wheel with multiple sensing areas according to another embodiment of the invention.

FIG. 4 shows the steering wheel of FIG. 3 in a rotated position.

FIG. 5 shows a schematic electrical diagram of the FIG. 1 embodiment.

FIG. 6 shows a schematic electrical diagram of the FIG. 3 embodiment.

### DETAILED DESCRIPTION OF PREFERRED AND OTHER EMBODIMENTS

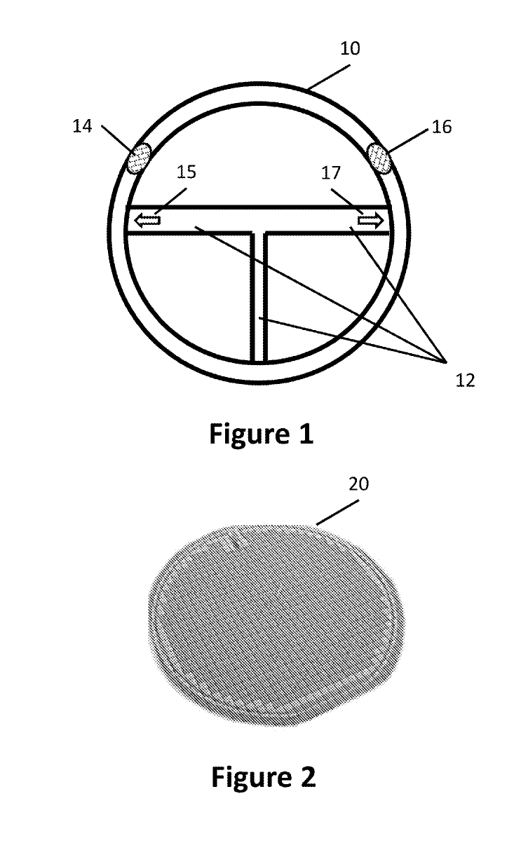

This invention provides a vehicle steering wheel with integrated sensing regions located on the steering wheel, preferably on the rim portion of the steering wheel. FIG. 1 shows a steering wheel with steering wheel rim portion 10 and spokes 12 which connect to a vehicle steering column (not shown). The rim portion of the steering wheel has a left sensing region 14 and a right sensing region 16. Preferably, the left sensing region 14 is located at the “10 o'clock” position (approximately 300 degrees) and the right sensing region 16 is located at the “2 o'clock” position (approximately 60 degrees) of the wheel, these being the positions of a driver's left hand and right hand on the steering wheel which provide a safe steering grip. The location of the sensing regions on the rim portion may be indicated to a driver by means such as a different texture and/or colour of the rim portion where the pads are located in comparison with the texture/colour of the remainder of the rim portion.

This invention contributes to improved safety standards, as the 10 o'clock/2 o'clock grip position promotes safer steering grip, and furthermore the vehicle indicators can be activated without the driver's hands needing to move from this 10 o'clock/2 o'clock position. The sensing regions are located at the normal position of a driver's hands, so there is no need for the driver to look at the steering wheel to determine the location of the sensing areas.

Sensing regions provide an output signal when pressure is applied within the region. A sensing region may comprise one or more membrane sensor pads 20 as illustrated in FIG. 2. The membrane sensor pads may contain one or more sensors which activate when pressure is applied between the sensing area and the steering wheel rim portion, for example when grasped by a driver in a clenched grip. Activation may involve closure of an electrical circuit or change in a characteristic, such as the capacitance or resistance at one or more sensor points. As each pad may have multiple sensors, each pad in effect presents multiple sensing areas or sensing points. The sensing regions/areas are preferably integrated flush with the rim portion of the steering wheel, and are preferably provided as an integrated solution that is functional and sturdy as well as being easy to clean and maintain.

Sensing regions/areas may be located at any radial position around the rim portion of the steering wheel, either facing toward the driver, or facing away from a driver, or partially or completely encircling radially the rim portion.

Sensing regions may be relatively small (less than the width of a typical driver's hand) or they may be relatively large (greater than the width of a typical driver's hand). Larger sensing regions allow a greater range of positioning of a driver's hands upon the steering wheel, whilst smaller sensing regions encourage more precise positioning of a driver's hands. Accordingly, whilst the 10 and 2 o'clock position is preferred sensor areas may extend around a significant portion of the rim, such as from the 8 to 11 o'clock positions for the left indicator region(s) and from the 1 to 5 o'clock for the right indicator region(s)

Turn indication is initiated by squeezing or clenching either the left sensing region or the right sensing region. As an example, squeezing the left (right) sensing region twice may activate a pre-specified or customisable number (for example two or three) of left (right) indicator blinks to indicate lane changing. Similarly, squeezing the left (right) sensing region three times may activate an indefinite number of left (right) indicator blinks to indicate an intention to turn a corner. Indicators work like current stalk-based models, with automatic deactivation once the corner is negotiated and straight tine steering recommenced. This may be achieved by use of a sensor which senses the rotational position of the steering wheel, and which produces a signal when the steering wheel returns to the straight ahead position. This signal deactivates the indicators.

A pre-specified or customisable driver action applied to the sensing region, white the indicators are activated, will deactivate the indicators. This driver action may for example be two squeezes or three squeezes of the sensing region on the same side as the direction of turn, or may be a single squeeze of the opposite sensing region, or may be a single squeeze applied to both sensing regions simultaneously.

The actions performed following a driver action on the sensing regions may be customisable to driver preference for four or more squeezes.

All or part of a sensing region may include illumination to confirm a driver's command. For example, activating a left turn indication may illuminate the left pad with an amber glow that would remain in place until the indication step is complete. If indication needed to be changed or cancelled, this may be signified with, for example, a red glow demonstrating that the cancel action had been completed. By incorporating visual indications within the sensing region, the traditional dashboard left/right arrow indicators are no longer required, with the visual indication being moved to a position which is more visually obvious to a driver. A visual indication may be provided on the relevant spoke of the steering wheel. FIG. 1 shows left visual indication area 15 and right visual indication area 17 located on spokes 12 of the steering wheel.

An audio signal may be activated when the turn indicator is activated. This audio signal may be the familiar sequence of clicks as currently used with stalk-activated indicators, or may be some other signal, for example a single beep for “left” and two beeps for “right”. Alternatively, a series of voice signals could be used, such as “Turning left”, “Turning right”, “Changing lane to left”, “Changing lane to right”, “Indication cancelled” and other appropriate voice signals.

A tactile feedback signal may also be activated when the turn indicator is activated, for example a vibration signal applied at the location of the sensing region which is activated. The tactile feedback may be synchronised to any visual or audio signal which is concurrently activated.

While a squeezing or clenching action of the sensing regions is preferred, other actions are possible. For example, the sensing region could partially or completely encircle radially the rim portion of the steering wheel, and be activated by a driver squeezing or clenching, or by a driver pulling their fingers towards the rim portion of the wheel, or by a driver pushing their thumb towards the rim portion of the wheel.

Faster and safer indication initiation is provided by this invention. Vehicles with automatic transmissions with ‘sportomatic’ shifters and steering wheel mounted gear paddles tend to feel more responsive than those without. Having to indicate from a stalk when all other functions are either automatic or steering wheel centric may seem a little disconnected and time consuming to a driver of such a vehicle, and providing steering wheel mounted indicator means overcomes this problem.

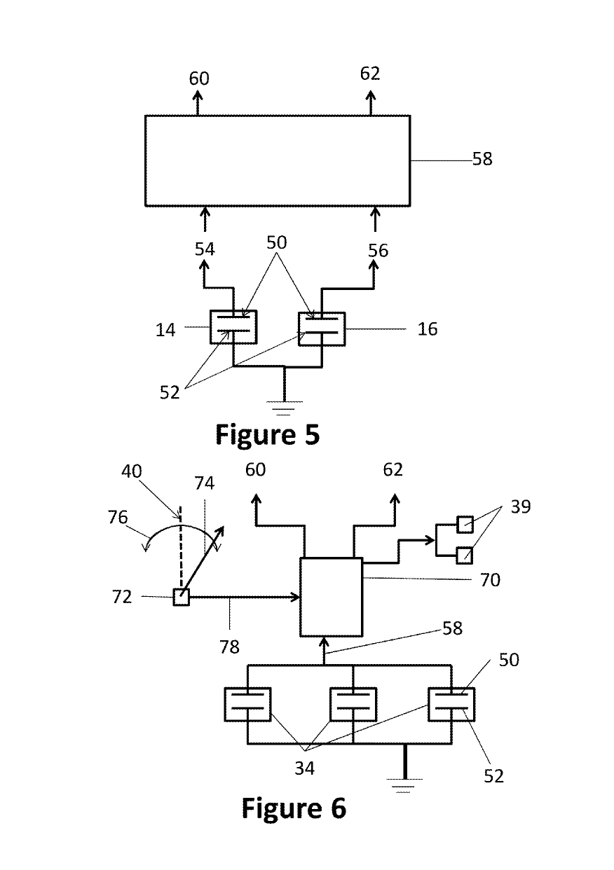

FIG. 5 schematically shows an electrical circuit corresponding to the arrangement of FIGS. 1 and 2. The sensor regions 14 and 16 in effect present as open switches with spaced contacts 50 and 52. Of course each sensor region 14, 16 may comprise a single pair of contacts 50 and 52 or multiple pairs. Contacts 52 may be electrically connected to ground, through the steering wheel. The other contacts 50 connect to outputs 54 and 56 respectively. These outputs 54 and 56 may connect directly into the vehicle's indicator system, with existing systems responding to a closed connection in a similar manner to when a signal is received from a conventional indicator wand. It will be appreciated that the electrical polarity may be reversed, with contacts connected to battery voltage +Ve, rather than ground.

Alternatively, the outputs 54 and 56 may connect to control module 58 which in turn outputs signals 60 and 62 for control of the left and right hand indicators into the vehicle management system or directly to the indicators. It will be appreciated that the sensors need not be connected directly into the vehicle's supply voltage and may connect into the control module. This allows use of non-contact type switches or sensors that do not in themselves need to close to generate a signal, such as capacitance or resistance type sensors.

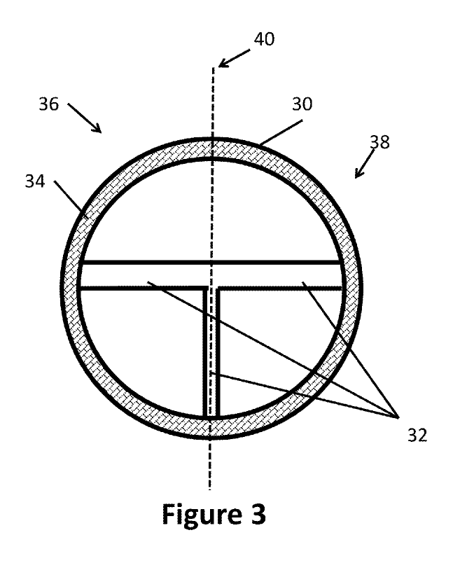

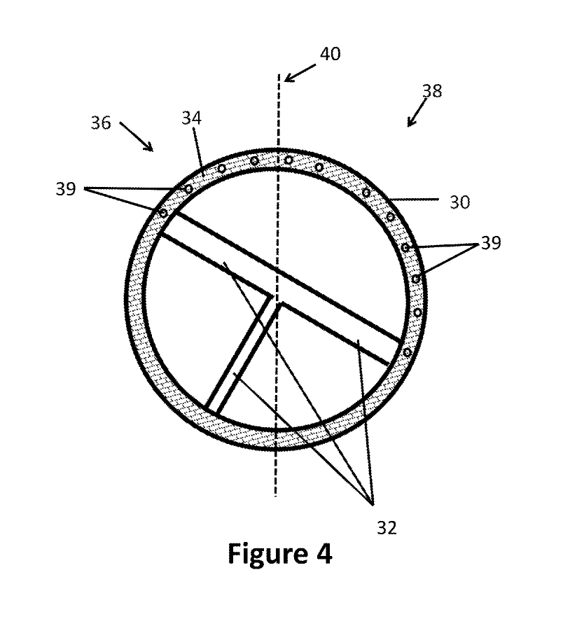

In another embodiment, one or multiple sensing areas 34 may be located circumferentially around all or most of the rim portion 30 of the steering wheel, as shown in FIG. 3. The sensing areas 34 may be located either facing toward the driver, or on the rim portion facing away from a driver, or partially or completely encircling radially the rim portion. By linking with a sensor which indicates the steering wheel's rotated position, each of the sensing areas 34 can be dynamically mapped. The position of the “left” (“right”) sensing area can be made to respond to a squeeze sequence on the left (right) side of a rotated steering wheel, rather than in reference to the steering wheel's normal straight position. For example, a squeeze in the left half 36 of a rotated steering wheel may indicate “left”, while a squeeze in the right half 38 may indicate “right”. FIG. 4 shows a steering wheel in a rotated position. The left half 36 (right half 38) is defined to be an area to the left (right) of the centre line 40 relative to the straight ahead position of the steering wheel as shown in FIGS. 3 and 4.

FIG. 6 schematically shows an electrical circuit corresponding to the FIGS. 3 and 4 embodiment.

The region of the steering wheel having sensors is schematically represented by a series of switches 34. The position of each switch 34 or closure point on the steering wheel can be easily determined using known techniques, such as those used for determining touch points on a touch screen or closure of a key on a keyboard. However, because the steering wheel can be rotated the position of a sensor or closure point may be on the left or right of the centreline and so may represent a left or right indicator command. In effect a specific sensor or closure point may be a “left” or “right” sensor depending on rotation of the steering wheel. Closure signal(s) 58 are fed to control module 70.

The system includes steering wheel angle sensor 72, which senses rotation of the steering wheel relative to centreline 40. The angle of rotation is schematically indicated by arrow 74 and left and right rotation is indicated by arrow 76. The sensed angle is input into control module 70 as indicated by 78. It will be appreciated that steering wheels can make more than one full rotation and so the angle detected may need to be translated. Thus a sensed steering angle of plus 390 degrees is the equivalent of plus 30 degrees.

Thus, for example, if the steering angle is +45 degrees clockwise it can be determined that a sensor area or closure point that is located 15 degrees counter clockwise (−15 degrees) from the 12 o'clock position on the steering wheel (when in the “straight ahead” position) is located 30 degrees clockwise of the centre line 40 and so is on the right hand side of the centre line 40. Accordingly, such a sensor area or closure point represents a “right hand” sensor area and so a “right hand” indicator type command should be generated.

As with the circuit of FIG. 5, the control module 70 may output appropriate signals 60 and 62 into the vehicle management system or directly to the indicators.

A visual confirmation signal, if provided, may be located at a sensing area different from the sensing area which is activated, so that the visual signal is not obscured by the driver's hands. For example, it may be located at a sensing area immediately adjacent to the sensing area which is activated, or it could be located on the leftmost/rightmost position of the rotated wheel, in reference to its rotated position, rather than in reference to its normal straight ahead position. Accordingly, the steering wheel may be provided with a series of notification areas 39 spaced about the rim. Areas 39 may each include a light source (visual areas) and vibrators to provide visual and vibration signals respectively. Preferably the light source(s) to be activated are dynamically mapped, preferably based on the rotated position of the steering wheel. The vibrators need not have the same mapping as the light source(s). The light source(s) and vibrators of the same area 39 need not be activated, so if both are used different areas may be activated.

Audio, visual and tactile functions would be optional and customisable.

Improved visual, tactile and audio notification will assist all drivers, and especially drivers with hearing impediments and failing short-range eyesight.

It will be appreciated that there need be no physical delineation of sensor regions or areas and any delineation may be logical rather than physical. This applies particularly where sensor areas extend around the entire circumference, in which case the entire rim may be logically broken into two or more regions or areas.

It will be appreciated that a single sensor assembly may represent multiple sensor areas. A sensor that is capable of differentiating different locations a driver input (such as pressure) has been applied to can be considered to represent multiple sensor areas. In effect, each separate location can be considered to be a separate sensor area.

It will be appreciated that the sensing areas may also be used to activate additional functions other than turn indicators, for example cruise control, horn activation, hazard lights or other functions.

The present invention is not limited to application in new vehicles, and can be retrofitted to older vehicles. Retrofitting would necessitate replacing the manufacturer provided steering wheel with a steering wheel according to the present invention or providing a steering wheel cover with appropriate sensors and control module. Retrofitting would enable drivers of older model automotive vehicles to leverage the indication technology of the present invention with its inherent increase in safety.

Unless the context clearly requires otherwise, throughout the description and any claims the words “comprise”, “comprising”, and the like are to be construed in an inclusive sense as opposed to an exclusive or exhaustive sense; that is to say, in the sense of “including, but not limited to”.

The features of the invention described or mentioned in this document may be combined in any combination of features where features are not mutually exclusive.

It will be apparent to those skilled in the art that many obvious modifications and variations may be made to the embodiments described herein without departing from the spirit or scope of the invention.

1. A steering wheel system for a vehicle having turn indicators with at least two sensing regions mounted upon or integrated within the steering wheel rim, wherein a driver action upon at least one of the sensing regions selectively activates or deactivates the turn indicators of the vehicle,
wherein each sensing region comprises at least one sensor area;
wherein, at the time of driver action upon a sensor area, a sensor area is a left or right sensor area, and
wherein a sensor area is dynamically mapped as a left or right hand sensor area.

2. The steering wheel system of claim 1 including a control module that transmits or generates indicator signals in response to one or more signals received from at least one sensing region.

3. (canceled)

4. (canceled)

5. (canceled)

6. (canceled)

7. The steering wheel system of claim 2 wherein the control module dynamically maps a sensor area as a left or right hand sensor area based on the rotational position of the steering wheel.

8. The steering wheel system of claim 7 including at least one notifier on or in the steering wheel to provide a notification corresponding to an action of the vehicle turn indicator, the at least one notifier selected from the group including a visual notifier, an audio notifier and a tactile notifier.

9. The steering wheel system of claim 8 comprising multiple notifiers and wherein the control module dynamically activates at least one of the notifiers.

10. (canceled)

11. The steering wheel system of claim 7 including a sensor which senses the rotational position of the steering wheel and provides a signal indicative of the rotational position of the steering wheel to the control module.

12. The steering wheel system of claim 1 wherein a driver action upon a left sensing area activates the left turn indicator of the vehicle and wherein a driver action upon a right sensing area activates the right turn indicator of the vehicle.

13. The steering wheel system of claim 1 wherein the turn indicators of a vehicle are selectively activated based on:
a signal or signals generated in response to a driver action upon at least one of the sensing areas, and
a signal representing the rotational position of the steering wheel.

14. The steering wheel system of claim 1 wherein a driver action upon any sensing area in the left half of the rotated steering wheel corresponds to the activation of a vehicle's left turn indicator, and a driver action upon any sensing area in the right half of the rotated steering wheel corresponds to the activation of a vehicle's right turn indicator.

15. The steering wheel system of claim 1 wherein a predetermined driver action activates or deactivates a specified indication sequence of the vehicle turn indicators.

16. The steering wheel system of claim 1 wherein a driver action comprises applying a driver input to the steering wheel rim portion at the location of at least one sensing region a specified number of times.

17. The steering wheel system of claim 16 wherein applying driver action at least two times activates a specified number of vehicle indicator blinks.

18. The steering wheel system of claim 16 wherein the number of vehicle indicator blinks is a function of the number of specified driver inputs.

19. The steering wheel system of claim 1 wherein a specified indication sequence continues until input of specified driver deactivation action on at least one sensing region or at least one sensor area.

20. The steering wheel system of claim 1 wherein the driver action upon a sensing area comprises squeezing, clenching tapping or otherwise changing the pressure or forces applied to the steering wheel rim portion at a location of at least one sensing region.

21. The steering wheel system of claim 1 wherein the activation or deactivation action includes the action of the steering wheel returning to the straight ahead position.

22. The steering wheel system of claim 1 wherein the sensing regions comprise at least one membrane sensor pad.

23. The steering wheel system of claim 1 wherein at least one left sensing region is located between the 8 and 11 o'clock positions of the steering wheel in its straight ahead position and at least one right sensing region is located the 2 and 5 o'clock positions of the steering wheel in its straight ahead position.

24. The steering wheel system of claim 1 wherein at least one left sensing region is located at about a “10 o'clock” position of the steering wheel in its straight ahead position and at least one right sensing region is located at about a “2 o'clock” position of the steering wheel in its straight ahead position.
